(19) United States
(12) Patent Application Publication
(10) Pub. No.: US 2008/0202881 A1
(43) Pub. Date: Aug. 28, 2008

(54) STARTER UNIT

(75) Inventors: Achim Menne, Crailsheim (DE); Daniel Flemmer, Crailsheim (DE)

Correspondence Address: BAKER & DANIELS LLP;111 E. WAYNE STREET, SUITE 800, FORT WAYNE, IN, 46802, US

(73) Assignee: VOITH PATENT GMBH, Heidenheim (DE)

(21) Appl. No.: 12/034,714

(22) Filed: Feb. 21, 2008

(30) Foreign Application Priority Data
Feb. 22, 2007 (DE) 10 2007 008 814.2

(51) Int. Cl. F16D 33/00

(52) U.S. Cl. 192/3.25

(57) ABSTRACT

The invention concerns a starter unit having a hydrodynamic clutch with a pump wheel and a turbine wheel which form together a torus-shaped working space, which can be filled and emptied with working medium by way of a supply and discharge medium. A circulatory flow of the working medium can be provided in said working space; at which a throttling component has been provided which can be moved by means of a pressure- controlled adjusting mechanism in order to affect the circulatory flow in and/or at the working space; and a mechanical bridging clutch having at least two coupling elements which can be placed in a friction-locked connection to each other via a pressure-controlled clutch-engaging device so that the pump wheel and the turbine wheel are torque connected.

The invention is characterized by the fact that the adjusting mechanism and the clutch-engaging device and clutch-engaging device can be impinged with working medium pressure via a control conduit that is separate from the working medium supply and working medium discharge, at which an adjusting control pressure required to pressure-control the adjusting mechanism and a clutch-engaging control pressure required to pressure control the clutch-engaging device, preferably differing by one pressure difference from the adjusting control pressure, can be applied in the control conduit.

The invention concerns a starter unit involving a hydrodynamic clutch

Hydrodynamic clutches are known. They have a pump wheel and a turbine wheel which are usually the only two bladed wheels of the hydrodynamic clutch. Accordingly, guide wheel has been provided. Frequently, hydrodynamic clutches are used in starter units, such as described in DE 103 53 519 A1, at which a mechanical clutch (bridging clutch) is arranged parallel to the hydrodynamic clutch. The hydrodynamic clutch is used for wear-free starting.

Usually, the pump wheel and the turbine wheel form together a torus-shaped working space, which can be filled and emptied with working medium by way of a supply and discharge medium. Said working medium can be, for example, oil, water or a water mixture. In the pump wheel, the working medium is accelerated to the outside, enters the turbine wheel and is decelerated and enters the pump wheel again. By means of this working medium cycle (circulatory flow), torque is transmitted wear-free from the pump wheel to the turbine wheel.

It is a known fact that hydrodynamic clutches can be arranged in stationary or movable throttling components in order to affect, especially specifically adjust, the working medium circuit and, as a result, the transmission behavior of the hydrodynamic clutch. For example, the patent application publication DE 103 53 518 A1 describes two alternative possibilities of providing throttling components. The first description provides for stationary throttling components moving in axial direction, i.e., in direction of the rotation axis of the hydrodynamic clutch, or in radial direction of the hydrodynamic clutch. Depending on the slip, said throttling components exert more of less throttling effect on the working medium circuit between the pump wheel and the turbine wheel. According to the second description, wall areas of the pump wheel moving in axial direction of the hydrodynamic clutch are provided as throttling component for movable in order to affect the working medium circuit.

The pamphlets DE 103 53 519 A1 and DE 103 53 554 A1 respectively disclose examples for the mode of operation of a generic driving unit, i.e., examples for a regulated operation of the throttling component and bridging clutch. By means of a pressure-controlled adjusting mechanism, the throttling component can be moved in direction of the rotation axis of the hydrodynamic clutch to affect the circulatory flow in and/or at the working space. The mechanical bridging clutch has several coupling elements which can be placed in a friction-locked connection to each other via a pressure-controlled clutch-engaging device so that the pump wheel and the turbine wheel are torque connected. Via a clutch-engaging pressure-controlled guide channel, the clutch-engaging device is connected to the working medium supply. The clutch-engaging device is pressure-controlled by means of the working medium pressure guided through the working medium supply. In DE 103 53 519 A1, the adjusting mechanism is pressure-controlled via a separately controlled valve unit. DE 103 53 554 A1, on the other hand, suggests to control the pressure-controlled adjusting mechanism also via the working medium supply and clutch-engaging pressure-controlled guide channel. In the process, the operating conditions of the clutch-engaging device and the adjusting mechanism result from a pressure difference between the pressure of the working medium guided through the working medium supply and the pressure prevailing in the interior (interior pressure) of the housing of the hydrodynamic clutch.

The embodiments of a generic starter unit designed according to prior art require a relatively high effort to control the pressure-controlled clutch-engaging device and adjusting mechanism. In the embodiment of DE 103 53 519 A1, an additional control for the separate valve unit of the adjusting mechanism has to be provided. Embodiment DE 103 53 554 A1 requires a relatively extensive control of the pressure difference between the pressure of the working medium guided through the working medium supply and the interior pressure. This control is complicated by the circumstance that the torque transmission behavior of the hydrodynamic clutch is dependant on the interior pressure which, in turn, is controlled by the working medium provided via the working medium supply.

Reference to the following documents is made to provide additional information regarding prior art:

EP 1 762 737 A2

U.S. Pat. No. 1,298,990

GB 954 504

DD 29 561

The invention is based on the objective of providing a starter unit which avoids the disadvantages of prior art and, in particular, simplifies the pressure control of the clutch-engaging device adjusting mechanism.

This objective is achieved by means of a starter unit according to the independent claim. The dependent claims represent preferred embodiments of the invention.

The invention-based starter unit involves a hydrodynamic clutch which has a pump wheel and a turbine wheel forming together a torus-shaped working space, which can be filled and emptied with working medium by way of a supply and discharge medium. It is possible to design in said working space a circulatory flow of the working medium. The invention provides a throttling component which can be moved by means of a pressure- controlled adjusting mechanism in particular in the direction of the rotation axis, i.e., in axial direction of the hydrodynamic clutch in order to affect the circulatory flow in and/or at the working space. It also provides a mechanical bridging clutch having at least two coupling elements. Said coupling elements can be tensionally locked, in particular friction-locked and/or form-closed to each other by means of a pressure-controlled clutch-engaging device, so that the pump wheel and the turbine wheel are or will be torque-proof connected.

According to the invention, for pressure control, the adjusting mechanism and clutch-engaging device can be impinged with working medium pressure via a control conduit that is separate from the working medium supply and working medium discharge. Consequently, there are at least three, precisely a total of three working medium conduits, namely the control conduit, the working medium supply and the working medium discharge. It is possible to connect to the control conduit an adjusting control pressure required to pressure-control the adjusting mechanism and a clutch-engaging control pressure required to pressure-control the clutch-engaging device. Preferably, said adjusting control pressure and clutch-engaging control pressure have a pressure difference in order to be able to initiate the pressure control successively via various control pressures. However, it is also possible to initiate pressure control of the adjusting mechanism and clutch-engaging device simultaneously. In this case, it is possible to increase the peed of changing gears, i.e., achieving faster mechanical torque transmission from the pump wheel to the turbine wheel.

By means of the invention-based separation of the control conduit in order to pressure-control the adjusting mechanism and clutch-engaging device, it is possible to control in a simple way the pressure control, largely independent of a supply or discharge of working medium in the working space. By moving the throttling component in and/or at the working space, it is possible to precisely regulate, in particular, the effect of the circulatory flow. It is possible to use for this purpose a control valve used already in known starter units.

Most expediently, the control conduit is formed, at least partially, by the hollow space of a hollow shaft. In this case, the hollow shaft forms the rotation axis of the hydrodynamic clutch. Such a hollow shaft is already commonly used in known starter units. As a result, established structural principles do not have to be modified significantly in order to achieve the invention-based advantages.

In order to be able to use reliable geometry also in the context of arranging the throttling component and bridging clutch, the adjusting mechanism advantageously involves an adjusting control pressure guide channel, and the clutch-engaging device involves a clutch-engaging pressure-controlled guide channel. Said adjusting control pressure guide channel and the clutch-engaging pressure-controlled guide channel diverge from the control conduit.

If the pressure control of the adjusting mechanism and the clutch-engaging device should be initiated in time-succession, it is most expedient if the adjusting mechanism and/or the clutch-engaging device have means for control force differentiation. Said means for control force differentiation produce a force adjusting the pressure difference which supports or counteract the pressure control of the adjusting mechanism and/or clutch-engaging device.

The latter can be achieved especially easy in that the means for control force differentiation include a spring at which a force produced by the spring counteracts the pressure control of the clutch-engaging device.

Alternatively, a differential pressure control valve can be provided which is preferably designed as a pressure relief valve. In this case, the differential pressure control valve is arranged in the control conduit between the gear of the adjusting control pressure guide channel and the gear of the clutch-engaging pressure-controlled guide channel. As a result, the pressure difference corresponds to the pressure in the control conduit required to open the differential pressure control valve. Such a differential pressure control valve can be easily installed in the control conduit.

An especially preferred element of the invention-based starter unit is a component of the adjusting mechanism that can be moved to pressure-control the adjusting mechanism which is pressure-movably arranged in a space that can be filled with working medium. During the process of displacement, displaceable working medium can be pushed out of the space via a flow-resistant opening in the space. Such flow resistance facilitates the precision alignment of the position of the throttling component during the process of displacement.

Subsequently, the invention will be exemplified by means of embodiments and enclosed figures.

It is shown:

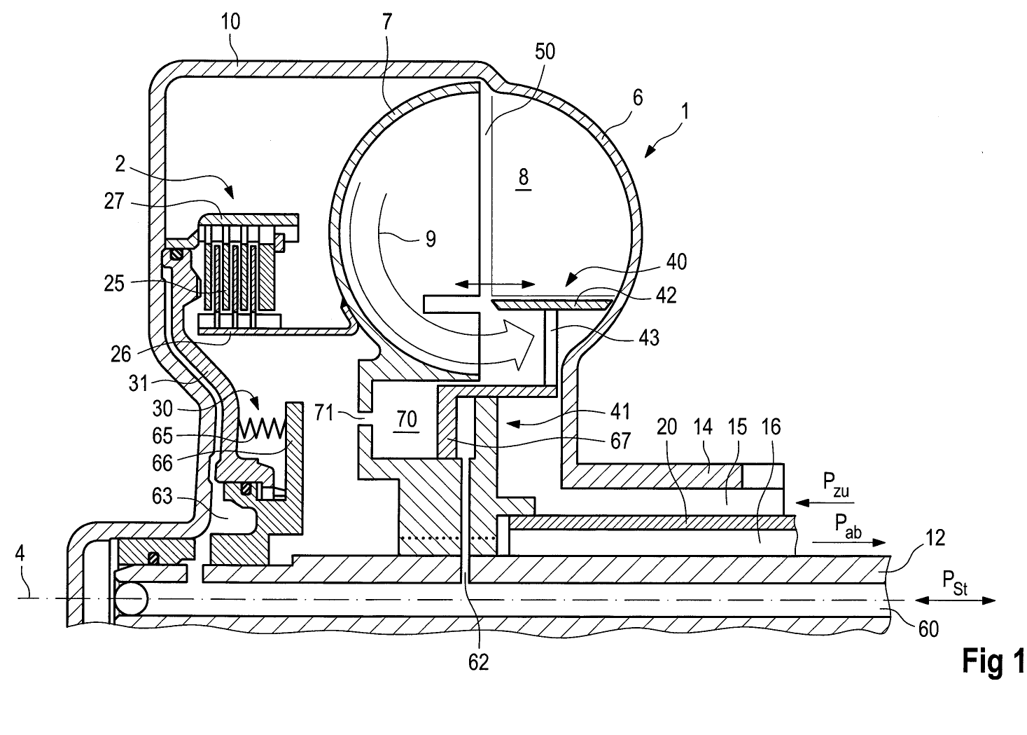

FIG. 1 an embodiment of an invention-based starter unit;

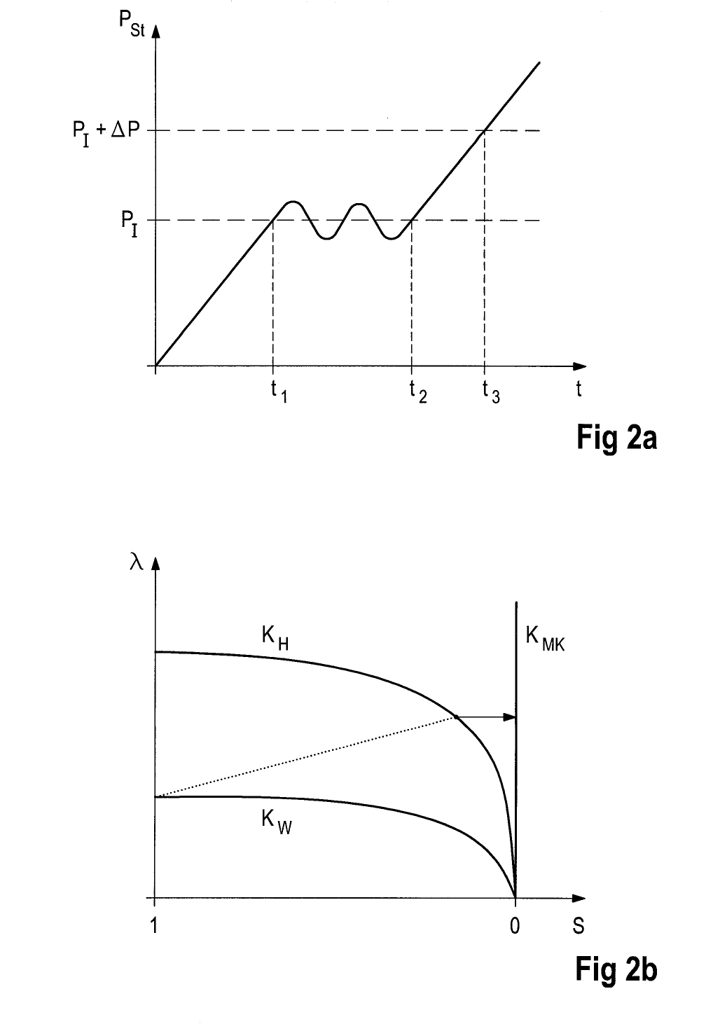

FIG. 2 the function of an invention-based starter unit represented by means of characteristic lines

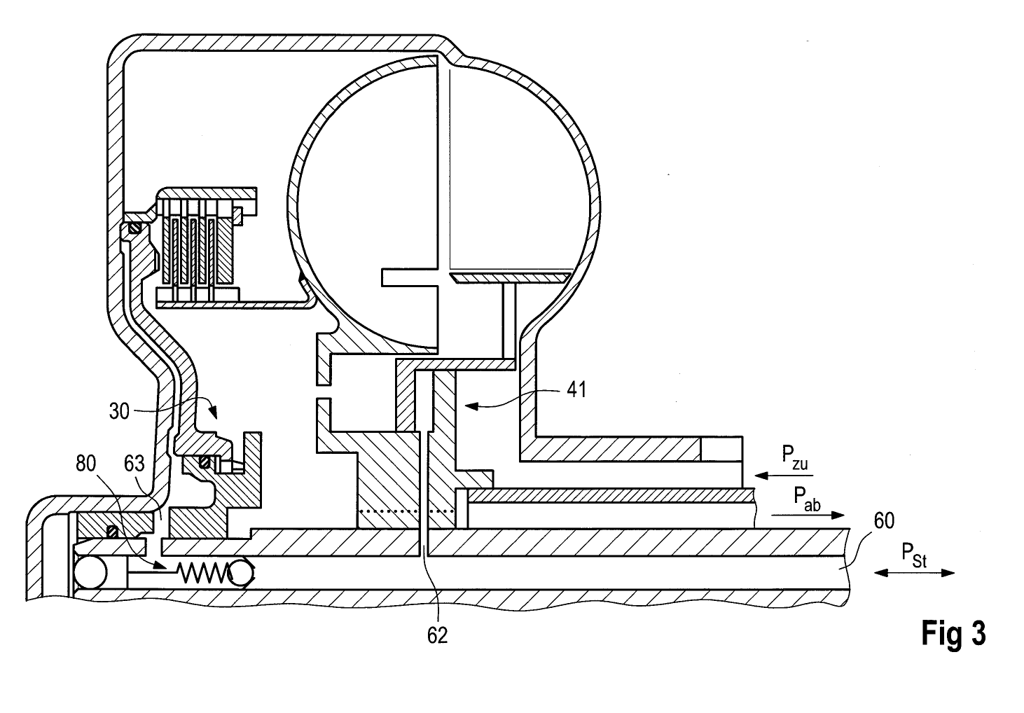

FIG. 3 a possible arrangement of a check valve to be used as differential pressure control valve as an alternative of the embodiment according to FIG. 1.

The figures in the drawings show the invention-based object in form of a diagram and do not correspond to full scale. The individual components of the invention-based object are represented in a way that clearly shows structure.

FIG. 1 shows a schematic axial cross-section through the invention-based starter unit having a hydrodynamic clutch 1 and a mechanical bridging clutch 2. It shows only one side above the rotation axis 4 of the starter unit, or the hydrodynamic clutch 1. It also shows the pump wheel 6 and the turbine wheel 7 which form together a torus-shaped working space 8 and in which a circulatory flow 9 of a working medium can be formed. The area of the working space 8 in which the circulatory flow 9 can be formed is characterized by an arrow. The pump wheel 6 is formed in such a way that is forms part of the housing 10 which basically encloses the entire starter unit. As a result, interior pressure P₁ is formed inside of the housing 10, within the interior space formed by the housing 10 and separated form the working space 8. The pump wheel 6 and the turbine wheel 7 are arranged in circular fashion around a hollow shaft 12 which forms the rotation axis 4 of the hydrodynamic clutch 1. A torque-producing starter unit can be connected in the area of the rotation axis 4 of the hydrodynamic clutch 1, or it can be connected to the housing 10 at the pump wheel 6. The turbine wheel 7 can be assembled in rotation stable fashion on the hollow shaft 12 so that the hollow shaft 12 can be connected to a subsequent driving element (output), for example, the shaft drive of a motor vehicle.

Between the hollow shaft 12 and a cylindrical end area 14 at the output side of the pump wheel 6, a working medium supply 15 and a working medium discharge 16 are designed. By means of these media, the working space 8 and the entire interior space can be filled with working medium and emptied. The latter can be controlled via a supply drive_{zu} attached to the working medium supply 15 and/or via a discharge drive_{ab} attached to the working medium discharge 16, which makes it possible to produce working medium flow direction characterized by arrows at the working medium supply and working medium discharge. The working medium supply 15 is separated from the working medium discharge 16 by means of a separating sleeve 20. The discharge of working medium toward the working medium discharge can be performed by means of discharge channels which are arranged in the center of the turbine wheel 7. Said discharge channels are characterized in the figure by means of a dotted line. The hydrodynamic clutch 1 is activated by filling the working space 8 with working medium via the working medium supply 15.

The bridging clutch 2 is arranged between the drive side of the housing area attached to the pump wheel 6 and the turbine wheel 7. It comprises several clutch disks 25 rotating around the rotation axis 4. Some of the clutch disks 25 are connected in rotation stable fashion to the turbine wheel 7 via a clutch member 26. The remaining clutch disks 25 are connected to the pump wheel 5 or housing 10 via another clutch member 27. By means of a pressing disk 31, the clutch disks 25 are mounted axially displaceable and can be placed in friction-locked connection via a pressure-controlled clutch-engaging device. As a result, the pump wheel 6 and the turbine wheel 7 can be torque connected to each other.

Inside of the working space 8, a throttling component 40 is provided. By means of a pressure-controlled adjusting mechanism 41, the throttling component 40 is movably arranged in rotational direction of the hydrodynamic clutch 1 in order to affect the circulatory flow 9. The throttling component 40 designed as a hollow cylinder 42 which is attached to the adjusting mechanism 41 by means of spokes 43, and which is arranged in circular fashion around the rotation axis 4 of the hydrodynamic clutch 1. The displayed position of the throttling component 40 is the active position of the throttling component 40. In this active position, a circulatory flow 9 forming in the working space 8 is discontinued or disrupted because the hollow cylinder 42 is in the flow range of the circulatory flow 9. By displacing the throttling component 40 in direction of the separating gap 50 between the pump wheel 6 and the turbine wheel 7, the throttling component 40 can be moved into an inactive position in which the circulatory flow 9 is not inhibited. As a result, only the spokes 43 remain in the circulatory flow 9. In this inactive position, the spokes 43 of the throttling component 40 are running in the separating gap 50 or in the area of the separating gap 50. The displacement can be performed by means of the adjusting mechanism 41 via adjusting control pressure. The displacement is characterized by the double-headed arrow in the working space 8 shown in FIG. 1.

For the purpose of pressure control, the adjusting mechanism 41 and the clutch-engaging device 30 can be impinged with working medium pressure P_{ST} via a control conduit 60 that is separate from the working medium supply 15 and working medium discharge 16. This can result in working medium flow in the control conduit 60 having a flow direction as characterized in the figure by a double-headed arrow at the control conduit 60. This control conduit 60 is formed by the hollow space of the hollow shaft 12.

The adjusting mechanism 41 comprises an adjusting pressure-controlled guide channel 62 and the clutch-engaging device 30 comprises a clutch-engaging pressure-controlled guide channel 63, both of which diverge from the control conduit 60. The hollow shaft 12 has at least one drill hole to form a branch for the adjusting pressure-controlled guide channel 62 and at least one drill hole to form a branch for the clutch-engaging pressure-controlled guide channel 63.

The clutch-engaging device 30 has a spring 65 as a means for control force differentiation. The spring produces a force which counteracts the pressure control of the clutch-engaging device 30. For this purpose, the spring 65 is arranged between a counter component 66 which cannot be moved in axial direction and the pressing disk 31. Apart from inner friction during pressure control, i.e., different tightness, of the adjusting mechanism 41 and clutch-engaging device 30, without the means for control force differentiation 41, the adjusting mechanism 41 and clutch-engaging device 30 would respond to the identical control pressure in the control conduit which exceeds internal pressure. Therefore, the means for control force differentiation defines the pressure difference required to pressure-control the adjusting mechanism 41 and clutch-engaging device 30. That means that the adjusting control pressure required to pressure-control the adjusting mechanism 41 and the clutch-engaging control pressure required to pressure-control the clutch-engaging device 30 differ by this pressure difference, in which case the clutch-engaging control pressure is larger than the adjusting control pressure.

The different control pressures can be installed in the control conduit 60, making it possible to pressure-control, via a controlled variation of the control pressure in one control conduit 60, the adjusting mechanism 41 and thus the throttling component 40, as well as to pressure-control the clutch-engaging device 30 and thus the bridging clutch.

For the purpose of pressure control, the control pressure affects one surface of a respective component which can be moved particularly against the inside pressure of the working medium. In the case of the clutch-engaging device 30, this component is formed by its pressing disk 31, at which the control pressure in the clutch-engaging pressure-controlled guide channel 63 affects the surface of the pressing disk 31 on the side of the housing. As a result, during pressure control for the purpose of pressing the clutch disks 25together, the interior surface of the housing moves the pressing disk 31 to the right, as shown in the figure.

The component 67 of the adjusting mechanism 41 which can be moved to pressure-control the adjusting mechanism 41, is located in a space 70 filled with working medium for pressure control. This space 70 is formed by the turbine wheel 7. The space 70 has a flow resisting opening 71 at which during the removal process, displaceable working medium can be moved out of this space 70 through this opening 71. The ends of the spokes 43 of the throttling component 40 located radially inside are attached to an end area of the displaceable component 67 of the adjusting mechanism 41 located outside of the space.

The FIGS. 2 emphasize the function of the invention-based starter unit by means of characteristic lines. In FIG. 2a, the control pressure P_{ST} to pressure-control the adjusting mechanism and the clutch-engaging device is applied above the time t, as it can be provided in the control conduit during a starting procedure. First, the control pressure P_{ST} is increased linearly up until it reaches the inside pressure P₁ in the interior space of the starter unit. The inside pressure P₁ is a function consisting of the pressures in the working medium supply P_{zu} and the working medium discharge P_{ab}. If the inside pressure P₁ is reached, the pressure control of the adjusting mechanism is performed in a period between the times t₁ and t₂. For this purpose, the control pressure P_{ST} varies by the approximate value of the insider pressure P₁. By means of this variation, the movement of the throttling component from an active to an inactive position can be precisely controlled. Therefore, torque transmission from the pump wheel to the turbine wheel can be increased in a way that prevents the drive unit from damage. During this period of control pressure variation, the presence of an opening, which forms a flow resistance and in which the displaceable component of the adjusting mechanism can be moved to achieve pressure control, also allows for a precise regulation of the position of the throttling component.

After the throttle component has been definitely moved to its inactive position at the time t₂ for the actual start-up procedure, the control pressure is further increased until it exceeds at time t₃ the value of the inside pressure P₁ by the pressure difference ΔP, amounting at least to P₁+ΔP. If this control pressure is reached, the clutch-engaging control pressure is achieved, so that the coupling elements of the bridging clutch are placed in a friction-locked connection via pressure-controlled clutch-engaging device, torque connecting the pump wheel and the turbine wheel. This concludes the start-up procedure of the invention-based starter unit. In order to reset the clutch-engaging device and the adjusting mechanism, the control pressure P_{ST} is again decreased below the inside pressure plus the pressure difference ΔP or inside pressure P₁.

FIG. 2b represents the start-up procedure of the starter unit described by means of the performance factor λ applied above the slip S between pump wheel and turbine wheel, i.e., the maximum transmitted torque. The slip depends on the speed of the turbine wheel n_{T} and the speed of the pump wheel n_{P} using the formula 1−n_{T}/n_{P}. Applied are the characteristic line of the hydrodynamic clutch positioning the throttling component in active position, the so-called soft line K_{W}, and the characteristic line of the hydrodynamic clutch positioning the throttling component in inactive position, the so-called hard line K_{H}. Both lines accept value zero if the slip corresponds to zero, i.e., if there is no speed difference between pump wheel and turbine wheel, since power transmission of a hydrodynamic clutch is possible only with speed difference. The characteristic line K_{MK} of the bridging clutch is also represented by a vertical line. If the clutch disks are placed in friction-locked connection, power transmission of a hydrodynamic clutch, i.e., at a slip of zero, is essentially unlimited. During the start-up procedure the throttling component is displaced from an active position to an inactive position. At the same time, because of increasing sped transmission, the slip from the pump wheel to the turbine wheel decreases. There is a transition from the soft characteristic line K_{W} to the hard characteristic line K_{H}, which is represented in FIG. 2b by means of a dashed line. This transition takes place between the times t1 and t2 featured in FIG. 2a. If the slip continues to decrease, the control pressure is increased in order to initiate the pressure control of the bridging clutch. This results in a transition from the hard characteristic line K_{H} to the characteristic line K_{MK} of the mechanical bridging clutch, as shown by the arrow in FIG. 2b. In the transition area between the hard characteristic line K_{H} to the characteristic line K_{MK} of the mechanical bridging clutch, the slip is further reduced because of the friction between the coupling elements of the bridging clutch.

FIG. 3 shows a possible arrangement of a check valve used as differential pressure control valve as an alternative to the means for control force differentiation of the embodiment represented according to FIG. 1. The check valve designed as a pressure relief valve which opens in case of excess pressure. The check valve is located in the control conduit 60 between the gear of the adjusting pressure-controlled guide channel 62 and the gear of the clutch-engaging pressure-controlled guide channel 63. The pressure difference between the adjusting control pressure required to pressure-control the adjusting mechanism 41 and the clutch-engaging control pressure required to pressure-control the clutch-engaging device 30 basically corresponds to the pressure in the control conduit 60 required to open the differential pressure control valve 80. To make it possible to empty the clutch-engaging pressure-controlled guide channel 63 while the differential pressure control valve 80 is closed, a discharge line (not shown) can be provided which ends in the clutch-engaging pressure-controlled guide channel 63 and which has, in particular, a relatively small cross-section, in particular a cross-section that is smaller than the cross-section of the control conduit 60 or clutch-engaging pressure-controlled guide channel 63.

The invention is not restricted to the embodiments described above. To the contrary, there are a number of possible variations which basically can utilize the characteristics of the invention even if they have different embodiments.

1. Starter unit having a hydrodynamic clutch with a pump wheel and a turbine wheel which form together a torus-shaped working space, which can be filled and emptied with working medium by way of a supply and discharge medium. A circulatory flow of the working medium can be provided in said working space;
at which a throttling component has been provided which can be moved by means of a pressure-controlled adjusting mechanism in order to affect the circulatory flow in and/or at the working space;
and a mechanical bridging clutch having at least two coupling element which can be placed in a friction-locked connection to each other via a pressure-controlled clutch-engaging device so that the pump wheel and the turbine wheel are torque connected;
Characterized by the fact that
the adjusting mechanism and the clutch-engaging device and clutch-engaging device can be impinged with working medium pressure via a control conduit that is separate from the working medium supply and working medium discharge, at which an adjusting control pressure required to pressure-control the adjusting mechanism and a clutch-engaging control pressure required to pressure control the clutch-engaging device, preferably differing by one pressure difference from the adjusting control pressure, can be applied in the control conduit.

2. Starter unit according to claim 1, characterized by the fact that the control conduit is, at least partially, formed by the hollow space of a hollow shaft, at which the hollow shaft forms the rotation axis of the hydrodynamic clutch.

3. Starter unit according to claim 1, characterized by the fact that the adjusting mechanism comprises an adjusting control pressure guide channel and the clutch-engaging device comprises a clutch-engaging pressure-controlled guide channel, at which the adjusting control pressure guide channel and the clutch-engaging pressure-controlled guide channel diverge from the control conduit.

4. Starter unit according to claim 1, characterized by the fact that the adjusting mechanism and/or the clutch-engaging device have means for control force differentiation, at which the means for control force differentiation produce a force adjusting the pressure difference which supports or counteract the pressure control of the adjusting mechanism and/or clutch-engaging device.

5. Starter unit according to claim 4, characterized by the fact that the means for control force differentiation include a spring, at which a force produced by the spring counteracts the pressure control of the clutch-engaging device.

6. Starter unit according to claim 3, characterized by the fact that a differential pressure control valve has been provided which is preferably designed as a pressure relief valve, at which the differential pressure control valve is arranged in the control conduit between the gear of the adjusting control pressure guide channel and the gear of the clutch-engaging pressure-controlled guide channel in such a way that the pressure difference corresponds to the pressure in the control conduit required to open the differential pressure control valve.

7. Starter unit according to claim 1, characterized by the fact that a component of the adjusting mechanism that can be moved to pressure-control the adjusting mechanism which is movably arranged in a space that can be filled with working medium, at which, during the process of displacement, displaceable working medium can be pushed out of the space via a flow-resistant opening in the space.

8. Starter unit according to claim 2, characterized by the fact that the adjusting mechanism comprises an adjusting control pressure guide channel and the clutch-engaging device comprises a clutch-engaging pressure-controlled guide channel, at which the adjusting control pressure guide channel and the clutch-engaging pressure-controlled guide channel diverge from the control conduit.

9. Starter unit according to claim 2, characterized by the fact that the adjusting mechanism and/or the clutch-engaging device have means for control force differentiation, at which the means for control force differentiation produce a force adjusting the pressure difference which supports or counteract the pressure control of the adjusting mechanism and/or clutch-engaging device.

10. Starter unit according to claim 3, characterized by the fact that the adjusting mechanism and/or the clutch-engaging device have means for control force differentiation, at which the means for control force differentiation produce a force adjusting the pressure difference which supports or counteract the pressure control of the adjusting mechanism and/or clutch-engaging device.

11. Starter unit according to claim 2, characterized by the fact that a component of the adjusting mechanism that can be moved to pressure-control the adjusting mechanism which is movably arranged in a space that can be filled with working medium, at which, during the process of displacement, displaceable working medium can be pushed out of the space via a flow-resistant opening in the space.

12. Starter unit according to claim 3, characterized by the fact that a component of the adjusting mechanism that can be moved to pressure-control the adjusting mechanism which is movably arranged in a space that can be filled with working medium, at which, during the process of displacement, displaceable working medium can be pushed out of the space via a flow-resistant opening in the space.

13. Starter unit according to claim 4, characterized by the fact that a component of the adjusting mechanism that can be moved to pressure-control the adjusting mechanism which is movably arranged in a space that can be filled with working medium, at which, during the process of displacement, displaceable working medium can be pushed out of the space via a flow-resistant opening in the space.

14. Starter unit according to claim 5, characterized by the fact that a component of the adjusting mechanism that can be moved to pressure-control the adjusting mechanism which is movably arranged in a space that can be filled with working medium, at which, during the process of displacement, displaceable working medium can be pushed out of the space via a flow-resistant opening in the space.

15. Starter unit according to claim 6, characterized by the fact that a component of the adjusting mechanism that can be moved to pressure-control the adjusting mechanism which is movably arranged in a space that can be filled with working medium, at which, during the process of displacement, displaceable working medium can be pushed out of the space via a flow-resistant opening in the space.
